(19) United States
(12) Patent Application Publication
(10) Pub. No.: US 2008/0240527 A1
(43) Pub. Date: Oct. 2, 2008

(54) Methods, Compositions and Systems for Analyzing Imaging Data

(75) Inventor: Charles Keller, San Antonio, TX (US)

Correspondence Address: MORGAN, LEWIS & BOCKIUS LLP (SF), One Market, Spear Street Tower, Suite 2800, San Francisco, CA, 94105, US

(73) Assignee: The Borad of Regents, The University of Texas System, a Instiution of Higher Learning

(21) Appl. No.: 11/839,414

(22) Filed: Aug. 15, 2007

Related U.S. Application Data
(60) Provisional application No. 60/822,412, filed on Aug. 15, 2006.

(51) Int. Cl. G06K 9/00

(52) U.S. Cl. 382/128

(57) ABSTRACT

The present invention provides methods, compositions and systems for the analysis of imaging data, in particular, whole-animal imaging data acquired using microCT. Included in the invention are methods for registering and comparing test images to one or more reference images to identify and analyze anatomical features of interest. Also provided by the invention are methods and systems for efficient, semi-automatic and fully automatic methods for generating morphological statistics for anatomical features contained in imaging data. Libraries of images, including raw data acquired from imaging apparatuses as well as processed images, are also encompassed by the present invention.

### CROSS-REFERENCE TO RELATED APPLICATIONS

The present application claims the benefit of the filing date of U.S. Provisional Patent Application No. 60/822,412, filed Aug. 15, 2006, which is incorporated by reference in its entirety for all purposes.

### FIELD OF THE INVENTION

The present invention relates generally to imaging, particularly whole-animal imaging. The invention also relates to analysis of images acquired using imaging techniques such as MRI and microCt, and to the development and use of libraries formed by compiling such images.

### BACKGROUND OF THE INVENTION

The ability to link a phenotype to a genotype requires identification of a causal relationship between a particular sequence in an organism's genetic code and some physical manifestation. For many physical manifestations, (including certain disease states, anatomical features, and developmental abnormalities) the genetic causes are not always linearly related to the phenotype, and there is instead a network of genetic factors that lead to a particular physical manifestation. As whole genomes continue to be sequenced and analyzed, the fields of bioinformatics, genomics and proteomics are shifting focus from simple gene and protein sequence analysis to methods and systems for describing gene function in the context of specific tissues of an organism. As a result, it is possible to relate development of certain anatomical features to particular genetic pathways.

Animal models are a powerful tool in the study of the link between phenotype and genotype, particularly animal models whose genomes have been selectively altered through genetic engineering. One way to use such animal models is to analyze the effect of genetic and pharmacological interventions on the development of the animal. Whole-animal imaging techniques are a useful way of studying the developmental progression of an animal as well as the effects of any interventions on that development. Such methods can be used to identify effects of interventions (such as pharmacology, gene therapy, radiation, and surgery) on certain anatomical (morphological) features.

One difficulty in using whole animal imaging techniques for detecting developmental and reproductive abnormalities is that quantitative comparison of images of different animals (as well as animals across different time frames) is not always possible using traditional analysis techniques. In order to conduct such studies, techniques and systems for consistently and accurately registering different images and identifying and comparing anatomical features of interest are needed.

### SUMMARY OF THE INVENTION

In a preferred aspect, the invention provides a method for comparing a query image of a test subject to a reference image of a reference subject. In this aspect of the invention, the reference image is selected from a virtual histology library. In a further aspect, comparing the query image to the reference image includes the steps of: (i) selecting an anatomical feature in the reference image; (ii) identifying corresponding landmark points in the query image; and (iii) registering the query image and the reference image using the landmark points, thus comparing the query image to the reference image. In a particularly preferred aspect, the anatomical feature comprises landmark points.

In another aspect, the invention provides a virtual histology library formed by compiling a plurality of reference images. In this aspect of the invention, each of the reference images contained in the virtual histology library is produced by a method which includes the steps of: (i) obtaining a microCT image of a reference subject; (ii) identifying landmark points in that microCT image; (iii) generating morphological statistics for a region around the landmark points; and (iv) processing the microCT image using the morphological statistics, thus producing the reference image. In a particularly preferred aspect, the microCT image of the reference subject is obtained using a method which includes the steps of: incubating a sample from a reference subject in a first staining composition which includes a first staining agent, thus producing a stained sample; suspending the stained sample in a liquid having a density lower than that of the stained sample; and scanning the stained sample in an X-ray computed tomography scanner to produce the microCT image of the stained sample.

In yet another aspect, the invention provides a method for indexing and retrieving stored images based on image content. This method includes the steps of: (i) selecting a plurality of features from each of a plurality of reference images of at least one reference subject—this plurality of features corresponds to distinct anatomical features of the at least one reference subject; (ii) recording the plurality of features from the plurality of reference images; (iii) indexing the plurality features from the plurality of reference images, using morphological statistics calculated for each of the plurality of features—this indexing forms a searchable library of the digital images; (iv) selecting a plurality of features from a query image; (v) calculating morphological statistics for each of the plurality of features from the query image; (vi) searching the library using the morphological statistics for the query image; and (vii) retrieving at least one reference image from the library using a similarity criterion. In a preferred aspect, this similarity criterion is calculated from the morphological statistics from the reference image and the morphological statistics from the query image.

In another aspect, the invention provides a computer implemented method for classifying a subject. This method includes the steps of: (i) obtaining an image of the subject; (ii) selecting an anatomical feature of the image; (iii) determining a distribution of values for the anatomical feature; (iv) calculating test indices for each of the values in the distribution of values for the anatomical feature; and (v) classifying the subject as normal or abnormal by comparing the test indices with reference indices stored in a virtual histology library. In a preferred aspect, the subject is classified as abnormal to an extent that there is a deviation of the test indices from the reference indices.

### BRIEF DESCRIPTION OF THE FIGURES

FIG. 1 is an example of output of a software application for comparing an experimental image to a reference or atlas image. FIG. 1A is a consensus (or averaged) image of an experimental group. FIG. 1B is a statistically averaged atlas image. FIG. 1C illustrates a user-interface for conducting a comparison between the images.

FIG. 2 is an example of output of a software application for identifying an image associated with a genotype. FIG. 2A is an image of an experimental animal. FIG. 2B is an image from a library associated with a particular genetic defect (knockout of the Pax3 gene).

FIG. 2C illustrates a user-interface for conducting a comparison between the images.

### DETAILED DESCRIPTION OF THE PREFERRED EMBODIMENTS

### Abbreviations

“MRI” refers to Magnetic Resonance Imaging.

“CT” refers to x-ray Computed Tomography; “microCT” refers to microscopic x-ray Computed Tomography.

“MRM” refers to Magnetic Resonance Microscopy.

“OCT” refers to optical coherence tomography

“EFIC” refers to Episcopic Fluorescence Image Capture

### DEFINITIONS

The singular forms “a,” “an,” and “the” include plural references, unless the context clearly dictates otherwise. Thus, for example, reference to “an image” encompasses one, two or more images.

The term “subject” refers to an organism that is the object of study or manipulation. A subject can be any organism, including cells, animals, and plants. A “reference subject” is generally a subject used as a standard, a control or as a comparison. A reference subject will generally represent a particular biological state, whether that biological state be a normal (i.e., non-manipulated or wild-type) or non-normal (i.e., manipulated or mutant) biological state. A “test subject” is generally a subject that has received some kind of biological or therapeutic intervention. A test subject and a reference subject may be different organisms, or they may be the same organism at different time points (i.e., before and after treatment with an agent).

The term “image” as used herein is used interchangeably with the term “imaging data” and includes data acquired directly from an imaging apparatus (such as a microCT scanner) as well as any data images that are processed using mathematical and statistical methods known in the art and described herein. A “test image” or a “query image” is an image taken of a subject which is the object of study (i.e., an experimental animal). A “reference image” is an image of a subject which has a known property or is associated with a biological or physical property or state. As used herein, the term “image” can refer to a two- or three-dimensional image.

As used herein, the term “is associated with”, as in A is associated with B, means that A refers to B, is B, identifies a feature of B, or indicates that B exists. For example, an image that is associated with a biological state can, by virtue of the data it contains, refer to that biological state, indicate the presence of that biological state, identify a feature of that biological state, or simply indicate that that biological state exists.

As used herein, the term “organism” refers to any living entity comprised of at least one cell. A living organism can be as simple as, for example, a single eukaryotic cell or as complex as a mammal. The term “organism” encompasses naturally occurring as well as synthetic entities produced through a bioengineering method such as genetic engineering.

A “biological state” encompasses a general physiological state as well as specific aspects of a biological or physiological state. For example, the term “biological state” can refer to a “control” or “normal” organism, and can also refer to a specific genotype or a specific phenotype, such as hair color or a particular anatomical feature.

The term “identifying” (as in “identifying an anatomical feature”) refers to methods of analyzing an object or property, and is meant to include detecting, measuring, analyzing and screening for that object or property.

The term “anatomical feature” as used herein refers to a particular area of anatomy. Anatomical features can be identified on a subject itself or on an image of the subject. Anatomical features include cells, tissues and organs. Unless otherwise indicated, “anatomical feature” and “feature” are used interchangeably.

The term “correlation” generally refers to the degree to which one phenomenon or random variable is associated with or can be predicted from another. As used herein, “correlation” can refer to statistical correlation, which refers to the degree to which a linear predictive relationship exists between random variables, as measured by a correlation coefficient. The term correlation is not limited to statistical correlation and may also refer generally to an observation or measurement of how similar one object is to another.

The term “registration” (as in “image registration”) refers to a method of matching an image to another image either rigidly or allowing non-rigid deformations. Any annotations or labels or points identified on one image can then be projected onto the other.

The term “diagnosing disease” encompasses detecting the presence of disease, determining the risk of contracting the disease, monitoring the progress and determining the stage of the disease.

The term “determining effectiveness of a treatment” includes both qualitative and quantitative analysis of effects of a treatment. Determining effectiveness of a treatment can be accomplished using in vitro and/or in vivo method. Determining effectiveness of a treatment can also be accomplished in a patient receiving the treatment or in a model system of the disease to which the treatment has been applied. In general, determining effectiveness of a treatment includes measuring a biological property at serial time points before, during and after treatment to evaluate the effects of the treatment.

“Treatment” generally refers to a therapeutic application intended to alleviate, mitigate or cure a disease or illness. Treatment may also be a therapeutic intervention meant to improve health or physiology, or to have some other effect on health, physiology and/or biological state. Treatment includes pharmacological intervention, radiation therapy, chemotherapy, transplantation of tissue (including cells, organs, and blood), and any other application intended to affect biological or pathological conditions.

A “property” is any biological feature that can be detected and measured.

As used herein, the term “tissue” includes cells, tissues, organs, blood and plasma.

The terms “query image” and “test image” are used interchangeably to refer to an image taken from a subject being studied (i.e., an experimental subject), as opposed to a subject used as a “reference” or “control” subject.

A “phenotype” is an observable physical or biochemical characteristic of an organism, as determined by both genetic makeup and environmental influences.

“Manipulation” (as in “manipulation to the animal”) refers to any internal or external procedure applied to a subject. For example, genetic manipulation can include gene therapy, genetic engineering, siRNA/miRNA administration, and transfection. Pharmacological therapy, radiation therapy, and surgery are also included in the term “manipulation”.

“Segmentation” refers to methods and systems of splitting an image up into segments or regions, wherein each of those segments or regions hold properties distinct from its neighbor. Segmentation methods are known in the art and described further herein.

The term “expressing” refers to the process of creating and producing a biological feature, including genes, proteins, and physiological characteristics. Expressing a gene includes induction or production of nucleic acids encoding the gene. Expressing a protein includes translation of mRNA to produce protein encoded by a particular gene. “Expressing” also encompasses changes in configuration or structure of molecular, anatomical and cellular structures.

The terms “nucleic acid” and “nucleotide” are used interchangeably and refer to DNA, RNA, single-stranded, double-stranded, or more highly aggregated hybridization motifs, and any chemical modifications thereof. Modifications include, but are not limited to, those providing chemical groups that incorporate additional charge, polarizability, hydrogen bonding, electrostatic interaction, and fluxionality to the nucleic acid ligand bases or to the nucleic acid ligand as a whole. Such modifications include, but are not limited to, peptide nucleic acids (PNAs), phosphodiester group modifications (e.g., phosphorothioates, methylphosphonates), 2′-position sugar modifications, 5-position pyrimidine modifications, 8-position purine modifications, modifications at exocyclic amines, substitution of 4-thiouridine, substitution of 5-bromo or 5-iodo-uracil; backbone modifications, methylations, unusual base-pairing combinations such as the isobases, isocytidine and isoguanidine and the like. Nucleic acids can also include non-natural bases, such as, for example, nitroindole; such nucleic acids may also be referred to as bases of non-naturally occurring nucleotide mono- and higher-phosphates. Modifications can also include 3′ and 5′ modifications such as capping with a quencher, a fluorophore or another moiety.

An amino acid or nucleic acid is “homologous” to another if there is some degree of sequence identity between the two. Preferably, a homologous sequence will have at least about 85% sequence identity to the reference sequence, preferably with at least about 90% to 100% sequence identity, more preferably with at least about 91% sequence identity, with at least about 92% sequence identity, with at least about 93% sequence identity, with at least about 94% sequence identity, more preferably still with at least about 95% to 99% sequence identity, preferably with at least about 96% sequence identity, with at least about 97% sequence identity, with at least about 98% sequence identity, still more preferably with at least about 99% sequence identity, and about 100% sequence identity to the reference amino acid or nucleotide sequence.

An “isolated” molecule, such as an isolated polypeptide or isolated nucleic acid, is one which has been identified and separated and/or recovered from a component of its natural environment. The identification, separation and/or recovery are accomplished through techniques known in the art, or readily available modifications thereof.

“Polypeptide” refers to a polymer in which the monomers are amino acids and are joined together through amide bonds, alternatively referred to as a peptide. When the amino acids are α-amino acids, either the L-optical isomer or the D-optical isomer can be used. Additionally, unnatural amino acids, for example, β-alanine, phenylglycine and homoarginine are also included. Commonly encountered amino acids that are not gene-encoded may also be used in the present invention. All of the amino acids used in the present invention may be either the D- or L-isomer. The L-isomers are generally preferred. In addition, other peptidomimetics are also useful in the present invention. For a general review, see, Spatola, A. F., in CHEMISTRY AND BIOCHEMISTRY OF AMINO ACIDS, PEPTIDES AND PROTEINS, B. Weinstein, eds., Marcel Dekker, New York, p. 267 (1983).

As used herein, “amino acid” refers to a group of water-soluble compounds that possess both a carboxyl and an amino group attached to the same carbon atom. Amino acids can be represented by the general formula NH₂—CHR—COOH where R may be hydrogen or an organic group, which may be nonpolar, basic acidic, or polar. As used herein, “amino acid” refers to both the amino acid radical and the non-radical free amino acid.

### Introduction

Researchers have gained new insights into the function of genes and gene products, but one task yet to be accomplished is to determine how these molecular processes are assembled into an organism. Advanced imaging techniques offer an important stepping stone to accomplish such a task, and quantitative analysis of images generated using such techniques are needed to allow comparison among different subjects across various points in time. The present invention provides methods, compositions and systems for conducting such quantitative analyses of images.

In a preferred aspect, the present invention uses virtual histology techniques to obtain images of subjects such as mouse embryos. Virtual histology techniques as described herein are used to generate 3-dimensional images of the mouse embryos. These images are then analyzed using techniques of the invention.

Generally, virtual histology images are analyzed by identifying anatomical features of interest, such as midbrain, forebrain, hindbrain, heart, lung and liver. These anatomical features of interest contain landmark points, which are identified either manually by a user or semi- or fully-automatically using a software application modified as described herein to implement methods of the invention. The landmark locations serve as the initiation points for applying a model, such as a statistical model, to define and outline the anatomical feature of interest. In a preferred embodiment, shape-based models are used for such a process. The process of identifying the landmark features and applying the model is also known as “segmentation” of the feature of interest. Following this segmentation procedure, morphological statistics can be calculated for the anatomical feature of interest. The segmentation data and the morphological statistics can be used to compare anatomical features of interest from images from different subjects and across points in time.

In a preferred aspect, the virtual histology images acquired using methods described herein are compiled into a virtual histology library (also referred to herein as a virtual histology atlas). The virtual histology library of the invention is a searchable and correlative library containing a plurality of images. These images can include the raw data generated from the image acquisition apparatus and can also include processed images which have been analyzed using the segmentation procedures and calculations of morphological statistics as described herein.

In a preferred embodiment, images acquired from a test subject are compared to images contained in a virtual histology library. This comparison includes registering the test image to the library image using landmark points. This comparison also includes comparison of morphological statistics generated for both the test image and the library image. This comparison of images can include statistical correlations, including generation of a similarity criterion, which can be used to determine whether a test image correlates to an image in the library.

### Imaging

Although exemplary embodiments discussed herein are directed to whole-animal imaging, the methods and compositions of the present invention encompass imaging of any biological sample from an organism, including samples of cells, tissues and organs.

Traditionally, effects of manipulations (such as genetic engineering, pharmacological treatment, toxins) on development have been studied using histological sectioning of mouse embryos, fetuses, or postnatal animals (newborn, juvenile, or adult). Such histological sectioning allows examination of morphological changes upon external or internal manipulation to the animal. However, traditional histological sectioning techniques are time-consuming and require extensive resources. As a result, data from such methods are generally very qualitative, because comparison between samples would require more intensive studies than is generally possible with traditional techniques. In addition, traditional histological sectioning is limited to two dimensions, thus limiting the interpretation of the results of the manipulation to the animal.

A variety of imaging techniques are known in the art, including without limitation MRI, MRM, microCT, EFIC, OCT, infrared tomography, and optical tomography. These techniques are applicable to whole-animal as well as tissue sample imaging. Whole-animal imaging can include without limitation imaging of an ex vivo embryo, an ex vivo fetus, a newborn, a juvenile and an adult animal. Animals that can be imaged using methods of the invention include without limitation mice, rats, zebrafish, frogs, and other animals known in the art and commonly used as subjects of genetic and biological manipulation and study. In a particularly preferred embodiment, the imaging is conducted on a mouse embryo.

Whole-embryo imaging provides the advantage of three-dimensional information that is statistically quantifiable. High throughput whole-embryo imaging in which multiple embryos are imaged at the same time, further increases the ability to compare among samples and generate quantitative results regarding morphological changes that result from a manipulation to the animal.

Magnetic resonance microscopy (MRM) provides the ability to screen mid- to late-stage mouse embryos for mutant morphological phenotypes (Smith et al., (1994), PNAS, 91: 3530-3533). This technique is applicable to embryos between the mid-sixth embryonic day of gestation until birth. One drawback to this technique is that the specialized and expensive equipment required for such high field magnetic resonance scans is not widely available. Furthermore, scans at useful resolutions (12-43 μm, but generally 25 μm) require significant amounts of instrument time (in the range of 9-14 hours) at a cost of approximately $200 per hour. MRM<which is also referred to as microscopic magnetic resonance imaging (μMRI), is performed using large magnetic fields and field gradients, provides a resolution to approximately 10 μm. This technique provides the ability to image the internal structures of opaque embryos without sectioning, which leaves the embryo in the most unperturbed state possible. Furthermore, μMRI is an excellent imaging modality for constructing 3D atlases, because small structures are resolved and are readily identified. As μMRI can collect images of living specimens, it offers the possibility of observing the 3D anatomy of the embryo as it develops (Parton R. G., (1994), J. Histochem. Cytochem 42:155-166).

Magnetic resonance imaging (MRI) is able to non-invasively capture the three-dimensional structure of complex tissues such as the human brain. Its capability to collect high-resolution images in settings that would scatter the radiation used in direct-imaging techniques makes MRI a powerful tool to observe events and structures deep inside otherwise opaque soft tissues. MRI exploits the nuclear magnetic resonance (NMR) effect, in which certain atomic nucleic can interact with radio waves when they are placed in a strong, applied magnetic filed. Almost all MRI experiments observe the proton that forms the ¹H nucleus that is present in water, fat and other biomolecules. In MRI, imaging is based on the linear relationship between the applied magnetic-field strength and the precessional frequency of the bulk magnetization.

### Virtual Histology

In a preferred embodiment, the invention provides methods of obtaining virtual histology images of animals and tissue samples using x-ray microscopic computed tomography (MicroCT). This technique is also described in PCT Application No. PCT/US2007/002264, filed Jan. 26, 2007, which is hereby incorporated by reference. The virtual histology technique permits mid-gestation mouse embryos to be scanned at about 1 to about 8 μm resolution in comparable or less time and at a fraction of the expense of magnetic resonance microscopy.

In one embodiment, a lower MicroCT resolution (27 μm) is used to simultaneously scan multiple embryos, and such scans provide adequate quality for post-imaging segmentation analysis allowing the recognition of gross and subtle mutant phenotypes. In one embodiment, 2-300 embryos are scanned at a time. In a preferred embodiment, 10-200 embryos are scanned at a time. In a particularly preferred embodiment, 60-120 embryos are scanned at a time.

For increased detail of abnormalities suspected on the low-cost 27 μm scans, the same osmium-stained specimens are later rescanned at 8 μm resolution for unprecedented detail of organ subcompartments and fine tissue structures. In this regard, MicroCT is useful as a first-time screen of embryonic defects, from which investigators then perform traditional histological/immunohistochemical analysis of regions of interest.

In a preferred embodiment, virtual histology methods of the invention employ staining compositions to differentially stain tissues. Such staining compositions includes a staining agent which produces an electron dense staining of one or more components of cells and tissues. In a preferred embodiment, the stating agent is present in the staining composition in an amount from about 0.01 weight percent to about 10 weight percent, more preferably from about 0.1 weight percent to about 5 weight percent, more preferably still from about 1 weight percent to about 3 weight percent. In a particularly preferred embodiment, the staining agent is osmium tetroxide. In a preferred embodiment, the staining agent includes about 0.1 to about 1.25 weight percent osmium tetroxide. In a further embodiment, the staining agent includes about 0.25 to about 1.15 weight percent osmium tetroxide. In a still further embodiment, the staining agent includes about 0.5 to about 1 weight percent osmium tetroxide.

In another embodiment, the staining agent includes phosphotungstic acid (PTA). Preferably, the staining agent includes about 3 to about 7 solution weight percent PTA. In a further preferred embodiment, the staining agent includes about 4 to about 6 solution weight percent PTA. In a still further preferred embodiment, the staining agent includes about 4.8 to about 5.2 solution weight percent PTA.

Further examples of staining agents that can be used to produce an electron dense stain to use in methods of the invention include ammonium molybdate; bismuth subnitrate; cadmium iodide; ferric chloride hexahydrate; indium trichloride; lanthanum nitrate; lead stains such as lead acetate, lead citrate, and lead nitrate; phosphomolybdic acid; potassium ferricyanide; potassium ferrocyanide; ruthenium red; silver stains such as silver nitrate, silver proteinate, and silver tetraphenylporphin; sodium chloroaurate; sodium tungstate; thallium nitrate; uranium stains such as uranyl acetate and uranyl nitrate; and vanadyl sulfate.

In a particularly preferred embodiment, staining compositions include a buffer which has a different osmotic concentration than the tissue that is to be stained. Such buffers can accelerate transfer of stain molecules into tissue cells. Such buffers can include phosphate buffered saline, cacodylate buffer, and other buffers known in the art. Staining agents can also be suspended in pure water before being applied using the buffer.

Further optionally, staining compositions of the invention can include an organic fixative and/or a tissue penetrating agent, including without limitation glutaraldehyde, formaldehyde, alcohols, DMSO, and combinations thereof.

In an example of a staining process used in methods of the invention, biological samples are stained to saturation overnight in a solution of 0.1 M sodium cacodylate (pH 7.2), 1% glutaraldehyde, and 1% osmium tetroxide, rocking at room temperature. Samples are then washed and dehydrated and incubated in a graded series of ethanol concentrations starting from about 20% to about 100% ethanol prior to scanning. The graded series of ethanol concentrations may also start from about 30%, 40%, 50%, 60%, 70%, 80% and 90% to about 100% ethanol. Ethanol is one example of a medium that is able to increase the apparent density differences between the suspension medium and the stained tissue.

In embodiments in which a fetus is the sample to be stained, the fetus is first blanched and skinned before staining. The fetus is dissected and removed of amnion and inner thin serosa membrane. A shallow cut is made on the ventral and dorsal sides of the fetus before the cut fetus is placed in a beaker filled with boiling water. The blanched fetus is then removed of epidermis/dermis. Additionally, several incisions are made on the skinned fetus to enhance stain penetration. Incisions are made external to the fetus, and preferably in the directions of lateral, supracostal, and vertical. The areas to be cut include, but are not limited to, the thoracic pleura, the peritoneum, and the dura matter.

For the staining of a tissue other than embryo or fetus, the tissue is first cut to ensure a certain thickness. The thickness is directly related to the amount of staining reagent to be effective. In a preferred embodiment, osmium tetroxide is used as a staining agent in a staining solution. In a particularly preferred embodiment, a staining solution containing osmium tetroxide in the range of 0.8 to 1.5 percent solution weight is used for staining a tissue section with a thickness less than 2 mm; a staining solution containing osmium tetroxide in the range of 1.5 to 2.2 percent solution weight is preferred for staining a tissue section with a thickness greater than 2 mm to speed stain penetration of the section thickness.

Methods of the invention may further include exposing the sample to a second staining agent to produce a double-stained sample. Advantageously, a second staining agent may stain a different cell or tissue component than the first staining agent. Such a second staining agent may be included in a staining composition with the first staining agent or separately, in a second staining composition.

A second staining agent may include a metal stain and/or a non-metal stain producing an electron dense product. An exemplary second staining agent includes ethidium bromide, cis-platinum, ammonium molybdate; bismuth subnitrate; cadmium iodide; ferric chloride hexahydrate; indium trichloride; lanthanum nitrate; lead stains such as lead acetate, lead citrate, and lead nitrate; phosphomolybdic acid; phosphotungstic acid; potassium ferricyanide; potassium ferrocyanide; ruthenium red; silver stains such as silver nitrate, silver proteinate, and silver tetraphenylporphin; sodium chloroaurate; sodium tungstate; thallium nitrate; uranium stains such as uranyl acetate and uranyl nitrate; and vanadyl sulfate.

In one embodiment, a combination of osmium and cis-platinum (or ethidium bromide) allows for differential staining of cell membranes and nuclei, respectively, so that the staining characteristics of organs and tissues are further differentiated.

In a further embodiment, osmium-stained tissue, with or without counterstains, is imaged and then sectioned for true histological staining. The multiple uses of osmium-stained tissues therefore speed the transition from microCT-based screens to episcopic and microscopic histological verification of suspected morphological phenotypes. (see, e.g, (Rosenthal et al., (2004), Birth Defects Res C Embryo Today, 72:213-223).

MicroCT-based virtual histology is not intended to replace the generally more versatile magnetic resonance methods, but is instead a useful adjunct for anatomical imaging. MicroCT-based virtual histology offers a higher resolution mode of morphometrics that is simple to implement, relatively inexpensive, and more rapid than comparable methods of phenotyping embryo anatomy.

### Analysis of Imaging Data

The increasing speed with which subjects can be imaged requires semi- and fully-automated methods of analyzing the resultant three dimensional imaging data. The present invention provides methods of analyzing these three dimensional imaging data, including integrated systems that combine a semi-automatic segmentation platform with a user-accessible interface. Such systems are designed for high throughput analysis of multiple subjects (such as mouse embryos) with minimal manual input required from the user.

In a preferred embodiment, a query image of a test subject is analyzed according to the invention by comparing the query image to a reference image. In a particularly preferred embodiment, the reference image is selected from a virtual histology library. In this embodiment, an anatomical feature in the reference image is selected. This selection may be accomplished manually or by using a semi- or fully automatic software application. In a particularly preferred embodiment, the anatomical feature encompasses landmark points.

The corresponding landmark points are then identified in the query image. Generally, corresponding landmark points in the query image are points in the image that are in the same approximate location and position in the query image as they are in the reference image. For example, if the anatomical feature selected in the reference image is the heart, and the landmark points in the reference image are located in an atrial cavity, the corresponding landmark points identified in the query image will also be located in an atrial cavity of the heart.

Preferably, landmark points in the query image are identified using semi or fully automated techniques which can include segmentation algorithms and other image based analysis techniques known in the art and described herein.

Once the landmark points in the query image are identified, the query image and the reference image are registered using the landmark points. This registration provides the ability to quantitatively compare the reference image to the query image by providing a way to identify the points in each image which correspond to the other. Registration of images is a fundamental task in image processing used to match two or more pictures taken, for example, at different times, from different sensors, or from different viewpoints. Registration techniques are known in the art. (see, e.g., Brown., (1992), ACM Computing Surveys, 24(4): 325-76). In a preferred embodiment, registration of images can involve a transformation of one or more of the images to account for differences in positioning and volume of the subjects of the images. Such transformations (also referred to as warping) techniques are known and established in the art.

In a further embodiment, comparing the query image to the reference image further includes the steps of generating morphological statistics for a region in the image that includes the landmark points. This region encompasses the landmark points and includes points surrounding the landmark points which also include a particular anatomical feature. In addition, morphological statistics are calculated for a region in the query image that includes the landmark points identified in the query image. A similarity criterion can then be calculated using the morphological statistics of the query image and the morphological statistics of the reference image. As used herein, the term “morphological statistics” includes any mathematical or statistical representation of a region in an image, where that region corresponds to an anatomical feature or to a part of an anatomical feature. Morphological statistics can be calculated using image processing methods known in the art and described herein, including segmentation methods and the application of shape-based models. Such segmentation methods and shape-based models are well established in the art. (see, e.g., US20060159341; Christensen, (1994) “Deformable shape models for anatomy,” Ph.D. dissertation, Washington University, St. Louis, US, 1994; Osada, et al., T (2002), ACM transactions on graphics, 21(4): 807-832, 2002; Joshi, et al., (2002), IEEE Transactions on Medical Imaging, 21(5): 538-550; and Miller et al., (1997), Statistical methods in medical research, Volume 6, pp. 267-299, 1997).

A “similarity criterion”, as used herein, refers to a value represented by a number, a pattern or a function, which can be used to determine whether two sets of data (such as two sets of morphological statistics) are similar. In a preferred embodiment, a similarity criterion is a numerical value, generally derived using known statistical methods from data such as morphological statistics. In a particularly preferred embodiment, a similarity criterion is compared to a threshold value, and if the similarity criterion exceeds the threshold value, this is an indication that the region encompassing the landmark points in the reference image correlates to the region encompassing the landmark points in the query image. This correlation may be a statistical correlation, in which case the similarity criterion may include a correlation coefficient, or the correlation may be a mathematical or statistical expression describing the similarity of the two images.

Segmentation Methods

Computer algorithms for the delineation of anatomical structures and other regions of interest are a key component in automating the analysis of imaging data. These algorithms, called image segmentation algorithms, play a vital role in imaging applications such as the quantification of tissue volumes, diagnosis, localization of pathology, study of anatomical structure, treatment planning, partial volume correction of functional imaging data, and computer-integrated surgery.

Segmentation of medical images is the task of partitioning the data into contiguous regions representing individual anatomical objects. Classically, image segmentation is defined as the partitioning of an image into nonoverlapping, constituent regions which are homogeneous with respect to some characteristic (such as intensity or texture). Segmentation can be challenging because the characteristics of the imaging process as well as the grey-value mappings of the objects themselves often make it difficult to separate the object being imaged from the background.

Methods for performing segmentations vary widely depending on the specific application, imaging modality, and other factors. For example, the segmentation of brain tissue has different requirements from the segmentation of the liver. General imaging artifacts such as noise, partial volume effects, and motion can also have significant consequences on the performance of segmentation algorithms. Furthermore, each imaging modality has its own idiosyncrasies with which to contend. There is currently no single segmentation method that yields acceptable results for every medical image. Methods do exist that are more general and can be applied to a variety of data. However, methods that are specialized to particular applications can often achieve better performance by taking into account prior knowledge (for example, atlas-based segmentation methods).

As a consequence of the nature of currently used image acquisition processes, noise is inherent in all imaging data. The resolution of every acquisition device is limited, and thus the value of each voxel (volume element) of the image represents an averaged value over some neighboring region (called the partial volume effect). Moreover, inconsistency in the data might lead to undesired boundaries within the object to be segmented, while homogenous regions might conceal true boundaries between organs. In general, segmentation is an application specific task.

Anatomy experts can overcome these problems and identify objects in the data using knowledge and information concerning typical shape and image data characteristics. Manual segmentation is, however, a very time-consuming process for large numbers of three-dimensional images, because they must proceed in a slice-by-slice fashion. The segmentation step is succeeded by surface mesh generation and simplification. For most research and clinical applications, the time and resources required by this amount of interaction is not acceptable. Hence reliable, semi-automatic and fully automatic methods for image segmentation are needed. A number of segmentation techniques are known in the art (for general review, see Bezdek et al., (1993), Med Phys., 20(4):1033-48; McInerney et al., (1996), Med Image Anal., 1(2):91-108; Pham et al., (2000) Annu Rev Biomed Eng., 2:315-37) and are also provided by methods, compositions and systems of the present invention.

During segmentation, parameters related to position and orientation of the anatomical feature of interest are optimized such that the model provides an acceptable approximation of the anatomical feature of interest within the image as a whole. The optimization is performed by analyzing the image data in a neighborhood of the model surface, e.g. by sampling profiles normal to the model's surface, and detecting edges or other specific characteristics. The exact strategy employed will depend on the image modality and the object to be segmented and will be selected using methods known in the art.

One popular segmentation approach is the use of deformable models. (see, e.g., McInerney et al., (1996), Medical Image Analysis, 1(2): pp. 91-108). A deformable model can be represented as an elastic surface, the shape and position of which can change under the influence of an ‘internal energy’ and an ‘external energy’. The internal energy serves to preserve the shape of the model (which may have been formed on the basis of prior knowledge concerning the structure to be segmented). The external energy can move the model surface in the direction of the object's edges and is derived from a three-dimensional representation of an object containing the structure. Such a three-dimensional representation of the object usually consists of a plurality of two-dimensional images, each representing a slice of the object. In a preferred embodiment, these three-dimensional representations are virtual histology images acquired using microCT techniques. Generally, the segmentation method employed in accordance with the invention finds those sets that correspond to distinct anatomical structures or regions of interest in the image.

Labeling is a process of assigning a meaningful designation to each anatomical region and feature of interest, and can be performed separately from or simultaneously with segmentation. Generally, labeling techniques map a numerical index to an anatomical designation. In medical imaging, the labels are often visually obvious and can be determined upon inspection by a physician or technician. Computer automated labeling is desirable when labels are not obvious and in automated processing systems. A typical situation involving labeling occurs in digital mammography where the image is segmented into distinct regions and the regions are subsequently labeled as being healthy tissue or tumorous. Such labeling techniques can be combined with segmentation methods and calculation of morphological statistics to produce indexed libraries of images which are sorted and searchable according to such labels, segmentation analysis parameters, and morphological statistics.

Atlas-guided approaches are a powerful tool for medical image segmentation when a standard atlas or template is available. The atlas (or library) is generated by compiling information on the anatomical feature that requires segmenting. This atlas is then used as a reference frame for segmenting new images. Conceptually, atlas-guided approaches are similar to classifiers except they are implemented in the spatial domain of the image rather than in a feature space. The standard atlas-guided approach treats segmentation as a registration problem (see Maintz et al., (1998), Med Im Anal, 2:1-36 for a survey on registration techniques). In general, a one-to-one transformation is used to map a pre-segmented atlas image to the target image that requires segmenting. This process is often referred to as atlas warping. The warping can be performed using linear transformations but because of anatomical variability, a sequential application of linear and non-linear transformations is often used. Because the atlas is already segmented, all structural information can be transferred to the target image.

Atlas-guided approaches have been applied mainly in magnetic resonance brain imaging. An advantage of atlas-guided approaches is that labels are transferred as well as the segmentation. They also provide a standard system for studying morphological properties, and the data from such study can be used to generate morphological statistics. Even with non-linear registration methods however, accurate segmentations of complex structures can be difficult due to anatomical variability.

Model or shape-fitting is a segmentation method that typically fits a simple geometric shape such as an ellipse or parabola to the locations of extracted features in an image. It is a technique which is specialized to the structure being segmented but is easily implemented and can provide good results when the model is appropriate. A more general approach is to fit spline curves or surfaces to the features. The main difficulty with model-fitting is that image features must first be extracted before the fitting can take place.

In a preferred embodiment, the invention utilizes a modified watershed algorithm. (see Cates et al., (2005) Med Image Anal. 9(6):566-78). The watershed algorithm uses concepts from mathematical morphology to partition images into homogeneous regions. Watershed algorithms in medical imaging are usually followed by a post-processing step to merge separate regions that belong to the same structure.

In a preferred embodiment, the present invention provides segmentation techniques utilizing a modified watershed algorithm and an atlas-based approach that employs shape-based statistical techniques.

Active shape and active appearance models (ASM and AAM) (Kass et al., 1987; Bajcsy and Kovacic, 1989) Cootes and Taylor (1999) are promising techniques for development of semi-automatic segmentation of imaging data based on statistical morphological atlases. These ASM and AAM methods vary in complexity from straight-forward point distribution models (Cootes et al., 1994) to sophisticated medial-axis based approaches (Pizer et al., 2003). In a preferred embodiment, the present invention uses an ASM segmentation platform based on point distribution models generated from hand-labeled training sets.

A major challenge associated with atlas-based segmentation techniques is developing the atlas itself. Common approaches to generating the initial segmentations are to apply other, often more manually intensive, techniques in order to generate very accurate segmentations for the training set. Examples include manually contouring, “boot-strapping” between slices with active contours (Kass et al., 1987), active blobs (Whitaker, 1994), level-set techniques (Sethian, 1996), and morphological watershed approaches (Beucher and Meyer, 1993). Cates et al. (2005) demonstrated that general, semi-automated techniques (e.g. watershed) could be used to rapidly segment features of interest with accuracy results that were comparable to and often exceeded those from expert manual segmentations. These methods and others known in the art and described herein are used to develop atlases (also referred to herein as libraries) according to the invention.

The following paragraphs describe examples of commercial and research tools for image segmentation may be of particular use in analyzing mouse embryos.

Insight Toolkit (Insight, 2005): The Insight Toolkit (ITK), funded by the NIH National Library of Medicine, is a collection of open-source libraries that implement state-of-the-art segmentation and registration algorithms. These algorithms include data processing filters such as Canny edge detection, Gaussian blurring, anisotropic diffusion, threshold-based classification, watershed segmentation, and level-set segmentation. The ITK library has been incorporated into several image processing and analysis applications as an underlying “segmentation engine”.

Amide (Amide, 2005): Amide is an open-source application for viewing, analyzing, and registering volumetric medical imaging data sets. It has limited segmentation support but runs on a variety of platforms (Linux, Windows, and Mac OSX).

Amira (Amira, 2005):Amira is a professional image segmentation, reconstruction, and three-dimensional model generation application produced by Mercury Computer Systems GmbH. It is designed as a general-purpose tool that handles a variety of imaging formats, including confocal microscopy, MRI, and CT data.

Analyze (Analyze, 2005): The Mayo Clinic developed Analyze for image processing and visualization of various types of 2D and three-dimensional imaging data. It incorporates several of the segmentation algorithms from the Insight Toolkit (ITK), exposing their functionality through a set of user interface tools.

BioImage and SCIRun (SCIRun, 2002): SCIRun is an open-source software system developed at the University of Utah. SCIRun can be graphically programmed by compositing processing components to generate end-user applications. BioImage is an example of a custom end-user application, developed atop the SCIRun platform. In a preferred embodiment of the present invention, the slice rendering and volume visualization capabilities of BioImage will be modified and incorporated into a user-accessible software platform for analyzing images according to methods of the invention.

Slicer (Slicer, 2005): 3D Slicer is freely available, open-source software for visualization, registration, segmentation, and quantification of medical data. It provides capabilities for automatic registration (aligning data sets), semi-automatic segmentation (extracting structures such as vessels and tumors from the data), generation of three-dimensional surface models (for viewing the segmented structures), three-dimensional visualization, and quantitative analysis (measuring distances, angles, surface areas, and volumes) of various medical scans.

MRPath's Voxstation (MRPath Voxstation, 2005): Voxstation offers users the ability to view large datasets and has basic segmentation tools. It is targeted at small-animal imaging scientists.

MicroView. (MicroView, 2005): MicroView is an open-source, freely distributed three-dimensional volume viewer. It can be used on various platforms including Windows, SGI, Linux, and Mac. Its capabilities include visualization and quantification of both two-dimensional and three-dimensional image data.

The above described commercially available tools are not particularly well suited to the problem of segmenting numerous mouse embryos. In general, commercially available segmentation tools are designed for the generic segmentation of arbitrary features, and they lack the customizations that would make them attractive to end-user scientists working in specific application domains. For example, Amide, Amira, Analyze, and Voxstation do not support atlas-based segmentation approaches. Further, with the more complex segmentation tools in ITK, there are often a large number of parameters that the user is required to specify. With so many choices and options, users are often simultaneously overwhelmed and frustrated as they try to segment their data without sufficient domain-specific guidance. Thus, in one aspect, the invention provides methods and systems for modifying and adjusting commercially available segmentation software and algorithms for use with the atlas-based (virtual histology library based) analysis methods of the present invention.

### Image Libraries

In a preferred aspect, the present invention provides libraries which contain one or more images obtained from one or more subjects. In a preferred embodiment, these images are of embryos. Although the exemplary embodiments described herein are directed to libraries containing virtual histology images (“virtual histology libraries”), it is noted that the libraries discussed may also contain images acquired by a variety of techniques not necessarily limited to virtual histology techniques.

In a preferred embodiment, libraries of the invention are searchable, correlative collection of images from a plurality of subjects. These images can be searched using algorithms known in the art. In a particularly preferred embodiment, these libraries are virtual histology libraries.

In an exemplary embodiment, the images in a virtual histology library are indexed using morphological statistics calculated for each image using methods known in the art and as described herein. In a particularly preferred embodiment, such morphological statistics can be used as a search parameter to correlate a test image to one or more of the images contained in the library. Such a correlation may be a quantitative correlation of patterns represented by such morphological statistics, or it may be a one-to-one identification of points in the test image which are contained in the image from the library. In an exemplary embodiment, a point distribution model of the right ventricular cavity of a heart in a test image is used as a search parameter to identify images in the library that have similar or identical point distribution models for that anatomical feature. A quantitative analysis can then be conducted to compare the point distribution model of the test image to the selected images from the library, and those images in the library which have point distribution models that meet a defined threshold in such a quantitative analysis are then identified as being correlated to the associated library images.

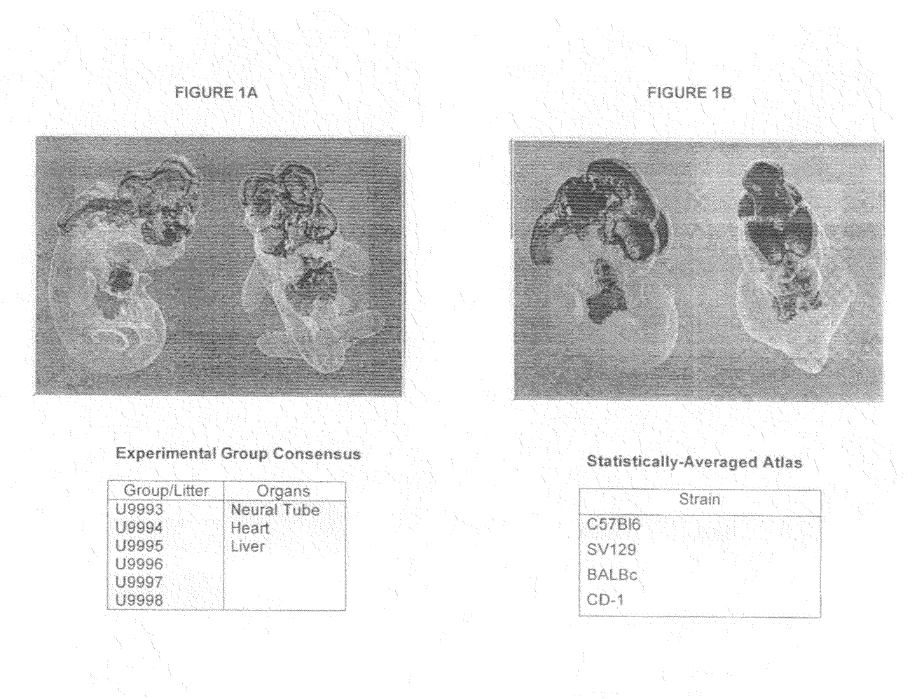

In another embodiment, images contained in a virtual histology library include images which are the result of a summation procedure in which two or more images of the same or different subjects are combined using methods known in the art to develop a “representative” image that includes features of the constituent image. (see FIG. 1 for an illustrative example of such representative images). In one embodiment, a pixel by pixel (or voxel by voxel) summation or averaging is conducted for two or more images registered using landmark points. The resultant averaged image is in one embodiment a representative of the constituent images. For example, a plurality of images from subjects associated with a particular genotype can be combined into a single representative image of that genotype using summation or averaging procedures known in the art.

In one embodiment, the averaging is accomplished through a series of registration steps. In the first step, the images are normalized with respect to orientation, location, scale, and intensity. This removes image differences unrelated to biological variations such as translations and rotations and also provides estimates of global size differences. A common space is also defined to represent images in a spatially unbiased fashion. A voxelwise average of the images in this orientation provides an initial average image estimate. Subsequently, nonlinear registration of the individual images to the average provides a new set of images that allows creation of an improved average representation. This process is repeated iteratively at progressively finer resolutions until the final average is achieved, at which point correspondence is achieved by shifting individual image voxels. The resulting deformation field represents all such voxel displacements and encodes the shape differences between each image and the population average. The set of deformation fields from all images encodes the population variability. It is convenient to quantify this variability as an average overall voxels of the root mean square displacement (after subtraction of the mean group changes). This is calculated directly from the deformation fields and serves to assess the relative sensitivity of each image analysis. Such average images can be used in a preferred embodiment as a reference for further analysis of other images in the library and of test and query images presented for comparison with images in the library.

In another embodiment, images contained in the virtual histology library include “difference” images in which a pixel by pixel (or voxel by voxel) subtraction is conducted between two images, such that the resultant image contains data directed to the differences among the two images. Such difference images can be used to identify anatomical features that have been affected by an internal or external manipulation to the subject of one or more of the images used to create the difference image.

Methods of the invention may be used to collect different images of tissue and animals having various characteristics. With a library of different images, it is possible to design algorithms based on the data contained within these images. Such algorithms can be used to develop morphological statistics of these images, which can in turn be used to determine whether a query or test image is similar to an image in the library.

In one embodiment, virtual histology libraries of the invention contain images of animals which have received some kind of treatment (such as pharmacological treatment, radiation therapy, and surgery). These images can include images of the same subject across a span of time before an after such a treatment. Such a library can also include images of multiple subjects, some of which have received the treatment and some of which have not.

In another embodiment, virtual histology libraries of the invention contain images of animals which are designated “control” or “normal” or “wildtype” animals. In another embodiment, such libraries can also contain images of “mutant” or “test” or “experimental” animals. In a preferred embodiment, libraries of the invention contain images in which particular anatomical features are associated with one or more particular genotypes, including genotypes designated as “normal” or “mutant” genotypes.

In a further embodiment, the libraries of the invention include information related to morphological statistics of the images contained in the library. In a still further embodiment, the images in these libraries are indexed according to these morphological statistics, such that the library can be searched and certain images retrieved from the library using morphological statistics as a search and retrieval parameter. In a particularly preferred embodiment, such searching and retrieval operations are accomplished using computer-based methods and algorithms.

In one embodiment, the libraries of the invention include morphological statistics and indices of anatomical features that can be used to register images of the libraries with test images of the same or different subjects than those used to obtain the images contained in the library.

In still another embodiment, the invention provides virtual histology libraries that can be used to provide information representative of a plurality of subjects and/or samples over a computer network, such as the internet. Subscribers to such information would include, for example, persons or businesses in the drug design, gene discovery, and genomics research fields. In this embodiment, each subscriber is granted access to all or part of the library (e.g., a subscriber may be granted access to data corresponding to only subjects that have received a particular kind of treatment) based on a subscription fee paid by the user. In addition to using the information in the libraries of the invention for general research purposes, the subscribers may also use such information to classify their own samples and subjects. For example, the user can measure morphological statistics for images acquired from their own subjects using methods such as those described herein and compare these statistics to the corresponding parameters in the images of the libraries of the invention. If the library contains images of “normal” subjects, for example, then the comparison of the library images with the user-supplied images can be used to classify the subject(s) of those user-supplied images as “normal” or “abnormal”.

### Using Virtual Histology Images and Libraries

The methods, compositions and systems described herein can be used in a wide variety of applications, and these “downstream uses” are encompassed by the present invention.

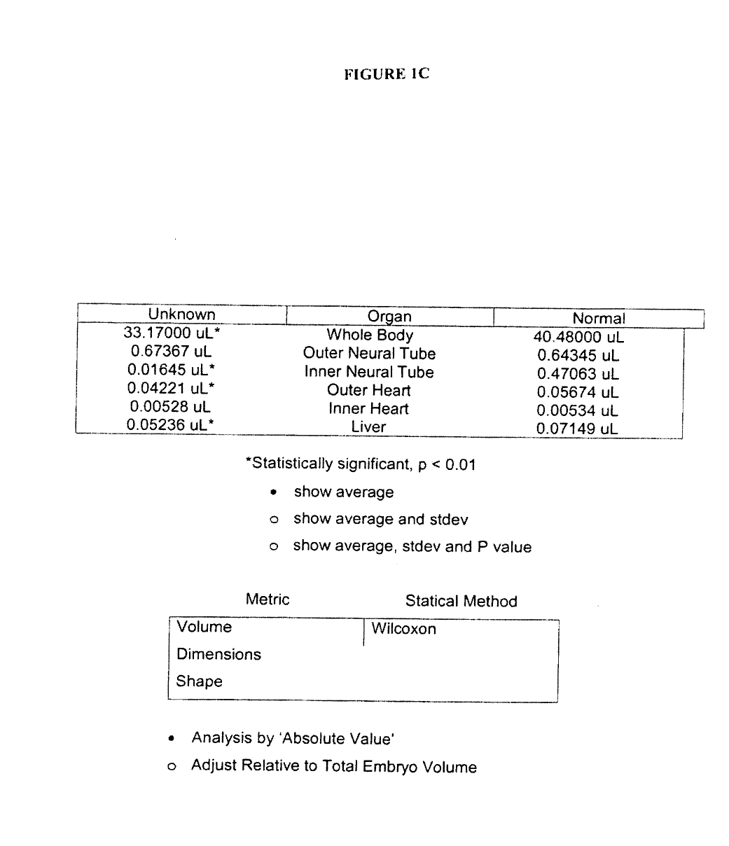

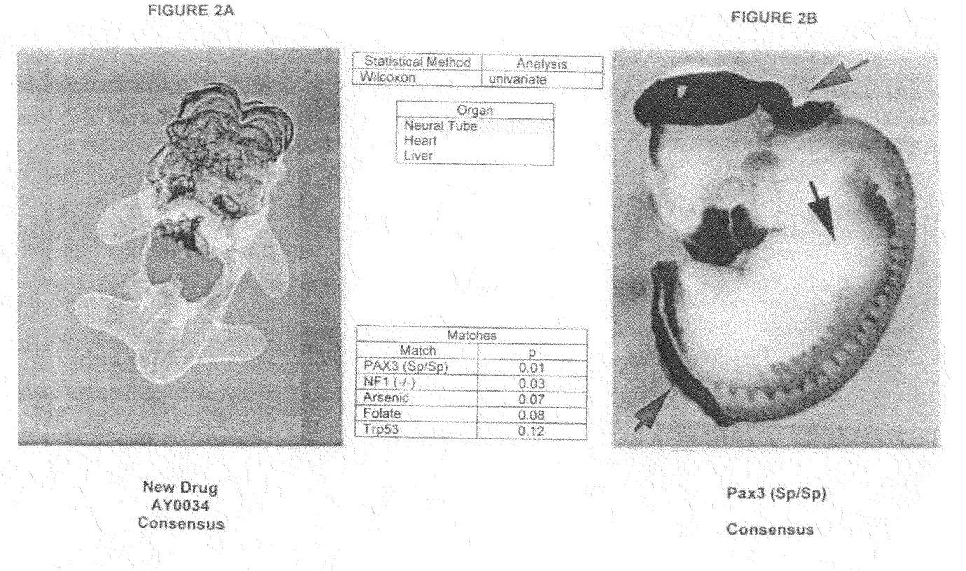

In a preferred aspect, the invention provides methods in which genetic differences between a test subject and a reference subject are identified by comparing the virtual histology images of the test subject and the reference subject. In this aspect of the invention, certain anatomical features and combinations of anatomical features in the images contained in the library are associated with particular genotypes. Comparing the library images to a test image can then indicate whether the subject of the test image is likely to also possess the same genotype. FIG. 2 provides an example of output of a software application which in accordance with the invention can be used to conduct such a comparison. In a further aspect, a similarity between the test image and a library image will indicate that the test subject is in an equivalent biological state as the reference subject as a result of genetic or epi-genetic (e.g., genomic, transcriptional, translational and post-translational) effects on the test subject.

To be “associated with” a particular genotype or a particular biological state as used herein means that an image contains anatomical features which are known or which have been shown to occur when the subject possesses a particular genotype or is in a particular biological state. For example, an image including anatomical feature “A” is associated with genotype “aa” if that anatomical feature is known to possess a particular shape (or is properly represented using a particular statistical or analytical model) when the subject of the image possesses genotype “aa”. In one embodiment, an image is associated with a particular genotype if it includes an anatomical feature that occurs when the subject possesses that genotype.

In another embodiment, an image is associated with a particular biological state if the image includes an anatomical feature that occurs when the subject is in that biological state. In a further embodiment, an image is associated with a particular biological state if it is an image of that biological state. For example, an image which includes an anatomical feature of a constricted aorta (also known as a coarctation of the aorta) can be associated with the biological state of heart disease. The image can also be associated with, i.e., is an image of, the biological state of the constricted aorta.

The reference images in the library may be associated with particular genotypes or particular biological states by a variety of methods. In one exemplary embodiment, reference subjects are manipulated using genetic engineering. These reference subjects thus possess a particular genotype. Images of these references subjects can reveal particular anatomical features, which can be identified and analyzed using the methods described herein. Such anatomical features, particularly those which are different from corresponding features in subjects that have not been manipulated using genetic engineering, can then be identified as being associated with (i.e., indicating) a particular genotype. Then, upon comparison to a query image, a similarity between the query image and a reference image indicates that the subject of the query image may also have that particular genotype. In a further embodiment, the similarity between the query image and the reference image will indicate that the test subject has the same genotype or has been affected by epi-genetic factors (e.g., genomic, transcriptional, translational and post-translational) that are “downstream” of that genotype and that result in a similar phenotype (i.e, anatomical feature).

A similar series of steps can be used to associate reference images with a particular biological state. For example, if a reference subject is known to be a “control” or “normal” animal, then particular anatomical features in an image of that reference subject will be “associated with”, i.e., indicate or refer to, the biological state of “normal”. Again, upon comparison of the reference image to a query image, the query image can be identified as being “normal” if it is similar to or correlates with the reference image associated with the normal biological state.

In further embodiments, reference images are associated with disease states, with treatments and therapies (including pharmacological treatment, radiation therapy, gene therapy, and surgery), exposure to toxin, and developmental defects (including genetic, spontaneous and idiopathic defects). In particularly preferred embodiments, reference images include whole-animal images as well as images of biological samples such as cells, tissues and organs. In a preferred embodiment, the whole-animal images are whole-embryo images. In a particularly preferred embodiment, the whole-embryo images are of mouse embryos.

In a preferred aspect, the invention provides methods for detecting genetic differences between a test subject and a reference subject which includes the steps of comparing a query image of the test subject with a reference image of the reference subject. For example, if reference image “A” has a particular anatomical feature which is associated with genotype “aa”, then a comparison of that anatomical features of reference image A with a query image can be used to determine if the query image has an anatomical feature which is similar to that in reference image A which is associated with genotype “aa”. If there is a similarity between the images, then the test subject is likely to also possess genotype “aa”. In the converse, if the corresponding anatomical feature in the query image shows a significant difference from that of the reference image, then this would indicate that the subject of the test image does not have that genotype.

The difference or similarity between the images described above can be determined by calculating a correlation between them. Such a correlation may be a statistical correlation of particular anatomical features of the images, or of mathematical representations (such as point distribution models) of those features. The correlation may include a comparison of morphological statistics generated for the query image and the reference image—such a comparison of morphological statistics can be accomplished using methods described herein.

The correlation may also be a pixel by pixel correlation between the images. Such correlation methods are known in the art. The correlation may also involve other mathematical and statistical tools to determine comparison values and correlation statistics. These tools include supervised or unsupervised classification models, multidimensional profile classification, linear discrimination and/or support vector machines, and boosted logistic regression. In addition, some well known statistical tests and procedures for research observations are: Student's t-test, chi-square test, analysis of variance (ANOVA), Mann-Whitney U, Regression analysis, factor analysis, statistical correlation, Pearson product-moment correlation coefficient, and Spearman's rank correlation coefficient. Methods for manipulating and analyzing data to detect and analyze patterns are also applicable to the determination of correlations described herein. For example, correlation can be determined using known pattern recognition methods and comparisons of frequencies of occurrence of properties. (see, e.g, Wang et al., eds., Pattern discovery in Biomolecular Data: Tools, Techniques and Applications, (1999); Andrews, Introduction to mathematical techniques in pattern recognition; (1972); Fu et al., eds., Applications of Pattern Recognition, (1982); Pal et al., eds., Genetic Algorithms for Pattern Recognition, (1996); Chen et al., eds., Handbook of pattern recognition & computer vision (1999); Friedman, Introduction to Pattern Recognition: Statistical Structural Neural and Fuzzy Logic Approaches, (1999) all of which are expressly incorporated by reference.) Such methods can be used with more “objective” data that lead to numerical values as well as with “subjective” data, such as expression patterns, color (of hair, eyes, skin), and tissue localization. Any of these mathematical and statistical tools, as well as others known in the art, can be used to compare images and determine if they are similar to each other.

In one aspect, the invention provides a computer implemented method for classifying a subject. This method includes the steps of: (i) obtaining an image of the subject; (ii) selecting an anatomical feature of the image; (iii) determining a distribution of values for the anatomical feature; (iv) calculating test indices for each of the values in the distribution of values for the anatomical feature; and (v) classifying the subject as normal or abnormal by comparing the test indices with reference indices stored in a virtual histology library. In a preferred aspect, the subject is classified as abnormal to an extent that there is a deviation of the test indices from the reference indices. In a particularly preferred embodiment, the distribution of values for the anatomical features in the image is calculated using methods described herein, including segmentation methods and the application of shape based statistical models.

In one aspect, methods, compositions and systems of the invention are used in studies of the effects of toxins on organisms. In a preferred embodiment, the methods, compositions and systems of the invention provide information on the effects of toxins on reproduction and development. For example, libraries of images can be used to determine whether test subjects which have been exposed to the toxin show any morphological changes. In an exemplary embodiment, an image of a test subject exposed to a toxin is obtained. This image is compared to images in the library using methods described herein. If the images in the library are of subjects that have not been exposed to the toxin, then differences between the image of the test subject and the images in the library can be identified as resulting from exposure to the toxin. In a further embodiment, if the library also contains images which are associated with a particular genotype, then a similarity between the image of the test subject and the library images can indicate that the toxin affects the test subject through pathways governed by that genotype. In a still further embodiment, libraries of the invention can be searched using morphological statistics calculated for the test image, as described herein. Thus, images in the library that include anatomical features with similar morphological statistics can be retrieved and further analyzed in comparison with the test image.

A similar method can be used to detect effects of particular treatments, such as pharmacological treatments, radiation therapy, and surgery, on a test subject. As discussed above, an image of a test subject exposed to a treatment is compared to a library of images. If the library of images contains images of reference subjects that have not been exposed to the treatment, then a difference between the image of the test subject and the image of the reference subject can be identified as resulting from the treatment. In addition, if the same or a different library also contains images which are associated with particular genotypes, then a similarity between the image of the test subject and the library images can indicate that the treatment exerts its effects through pathways governed by those particular genotypes.

In one exemplary embodiment, images in the library are associated with particular developmental defects with known or suspected genetic causes. In this embodiment, if a test image—such as an image obtained from a subject exposed to a toxin or to a drug candidate—is found to be similar to one of the images in the library, then this similarity indicates that the toxin or drug candidate can cause the associated developmental defect. In such an embodiment, the subject is generally exposed to the toxin or drug candidate in utero and then harvested and studied using methods described herein.

In a further embodiment, the library of images includes images acquired across a range of development. Such a library can be used to pinpoint the stage of development at which a particular toxin or treatment asserts its effects on the embryo.

Methods, compositions and systems of the invention may also be used in drug validation studies. For such studies, images of a test subject exposed to a drug candidate can be compared to a reference image of a control subject, where that control subject represents a normal animal. Thus, a difference between the test subject image and the image of the control subject would indicate an effect of the drug candidate. Identifying genes that may underlie the effect manifested in the test subject can also be accomplished using libraries of reference images which contain images of subjects that are associated with particular genotypes. In such an embodiment, if the test image is similar to one of these genotype-associated images, this would indicate that the drug causes a similar phenotype to what is associated with that genotype. Such an identification could point researchers in the direction of the “off-target” genes that may be affected by the drug, allowing them to alter the drug to avoid interaction with those off-target genes.

Tests mandated by EPA/FDA for preclinical evaluation of chemicals, pesticides, consumer hygienic goods, food additives, and pharmaceuticals can be accomplished using methods, compositions and systems of the invention as described herein. For such applications, images of subjects exposed to the regulated substance can be compared to images of subjects that have not been similarly exposed as well as to images of subjects that are associated with particular genotypes and/or developmental defects. Thus, if a substance under investigation does cause a difference in anatomical features between the test subject and a “normal” subject, other reference images acquired using methods of the invention can be used to pinpoint a particular genotype or a particular developmental stage which is involved in the substance's effect. Tests mandated by the EPA and FDA include tests promulgated under the Federal Insecticide, Fungicide and Rodenticide Act, and tests promulgated under the Toxic Substances Control Act.

The present invention may be better understood by reference to the following non-limiting Examples, which are provided as exemplary of the invention. The following examples are presented in order to more fully illustrate preferred embodiments of the invention, but should in no way be construed as limiting the broad scope of the invention.

While this invention has been disclosed with reference to specific embodiments, it is apparent that other embodiments and variations of this invention may be devised by others skilled in the art without departing from the true spirit and scope of the invention.

All patents, patent applications, and other publications cited in this application are incorporated by reference in the entirety.

### EXAMPLES

### Example 1

### Collecting Mouse Embryo MicroCT Data

### Virtual Histology

Litters of pure-strain C57BL/6 mice are generated using standard husbandry techniques. Mating cages of one sire and two dams are established, and dams are monitored each morning for the presence of cervical mucous plugs. The presence of a cervical plug is taken as evidence of successful impregnation, and the morning that a cervical plug is found is designated embryonic day E0.5. Mouse litters are harvested on embryonic day E12.5 following euthanasia of the pregnant dam. Amnion and placenta are dissected away from the embryos under a dissecting microscope. Embryos are then fixed in 10% buffered formalin overnight at 4° C. Generally, sixty embryos are harvested for microCT imaging.

For microCT-based virtual histology, formalin-fixed embryos are stained to saturation overnight in a solution of 0.1M sodium cacodylate (pH 7.2), 1% glutaraldehyde, and 1% osmium tetroxide rocking at room temperature. Embryos are then washed for 30 minutes in 0.1 M sodium cacodylate buffer, and twice more for 30 minutes in phosphate-buffered saline. Samples are then transitioned by a series of gradients to 100% ethanol prior to scanning.

High-resolution volumetric CT of the embryos are performed at 8 μm³ isometric voxel resolution using an eXplore Locus SP MicroCT specimen scanner (GE Healthcare, London, Ontario). This volumetric scanner employs a 3500×1750 CCD detector for Feldkamp conebeam reconstruction. The platform-independent parameters of current, voltage, and exposure time are kept constant at 100 μA, 80 kVP, and 4000 ms, respectively. For each scan, 900 evenly spaced views are averaged from 8 frames/view, filtered by 0.2 mm aluminum. At 8 μm resolution, the field of view of this instrument is 15×15×15 mm. Each scan takes approximately 12 hours, and six embryos can be scanned in the same 12-hour interval. Images are reconstructed with the manufacturer's proprietary EVSBeam software. Raw data and reconstructed image files are archived to duplicate DVD disks.

### Example 2

### Analysis of MicroCT Data Sets

A modified version of an existing watershed-based segmentation software system (Cates et al., (2005) Med Image Anal. 9(6):566-78) is used for segmenting features of interest (forebrain, midbrain, hindbrain, heart, and liver) from mouse-embryo MicroCT data. A set of robust landmark locations are used to grossly locate each feature of interest. These landmark locations are a subset of the full point distribution model (PDM). The landmark points generally meet certain requirements, including: they are easily identifiable in the data scans (e.g. a well-defined junction or cusp), they span the feature (e.g. several points on each side), and the number of landmarks are limited (i.e. only as many as an expert can label in under five minutes).

Based on the locations of the landmarks, the rest of the PDM points are distributed across the rest of the features' surface. An interactive software system, which modifies a commercially available application such as BioImage, is developed for labeling landmark and PDM points. In a preferred embodiment, the hardware used with this software includes: a 3 GHz Pentium with at least 1 GB of RAM, and a modern graphic card that supports shader programs (e.g. an ATI Radeon of NVIDIA FX card). The software is developed for the Window XP operating system using the Microsoft Visual Studio Net environment. Graphic-intensive rendering and visualization algorithms are implemented with OpenGL, and the software architecture makes use of pthreads for parallelism. Agile programming methodologies are applied for software engineering.

PDMs are generated based on sets of labeled points and the original scan data. The PDMs describe the distribution of locations for each point of a feature, as well as the statistics for the intensity profile along with a vector normal to the surface at each point (Cootes et al., (2004) Br J Radiol., 77 Spec No 2:S133-9). Inter-object relationships can be used for atlas-based segmentation. The explicit representation of inter-object poses helps constrain the search for each individual feature, and facilitates pose initialization.

A tool for rapidly segmenting new data sets based on the statistical model as discussed above is developed. Active Shape Models (ASM) are used to locate features of interest in new data sets. ASMs use optimization methods (iterative search, genetic algorithms, etc) to locate the most likely instance of the feature in the new data. They are typically sensitive to the initiation of the search, and a simple interface is implemented to facilitate rapid accurate initiation. The approach is to have the user locate the landmark point locations in the new data set, and fiducial points are used to drive the optimization of the other PDM locations.

Another software enhancement to the platform is to implement an optimization algorithm for locating the PDM locations based on landmark initializations in a new data set. A two-stage iterative solution with directional weighting is used. The optimization is interactive where the user is provided with rapid quantitative and qualitative feedback on the goodness-of-fit for the features once they have been located.

The robustness of PDMs and ASMs is validated through cross-validation. Specifically, the sixty embryos are divided randomly into ten groups of six data sets. Then ten simulation runs are conducted. Each time a different group is withheld and a new PDM model is generated form the remaining nine groups. PDM model is used to drive the ASM segmentation of the withheld group. For each run, the accuracy of the resulting segmentation is evaluated. A sensitivity analysis is also run to quantify the sensitivity of the ASM-driven segmentations to noise in the landmark-based initiation. For each of the above training runs, the landmarks are randomly perturbed in random directions by different levels of noise: first by two voxels, then by five voxels, and finally by ten voxels. For each noise level, the amount of error introduced into the segmentation is recorded.

We claim:

1. A method for comparing a query image of a test subject to a reference image of a reference subject, wherein said reference image is selected from a virtual histology library, and wherein said comparing comprises:
(a) selecting an anatomical feature in said reference image, wherein said anatomical feature comprises landmark points;
(b) identifying corresponding landmark points in said query image; and
(c) registering said query image and said reference image using said landmark points, thereby comparing said query image to said reference image.

2. The method of claim 1, wherein said comparing further comprises:
(a) generating morphological statistics for a region comprising said landmark points in said reference image;
(b) generating morphological statistics for a region comprising said landmark points in said query image;
(c) calculating a similarity criterion for said morphological statistics for said reference image and said morphological statistics for said query image.

3. The method of claim 2, wherein said similarity criterion is compared to a threshold value, and if said similarity criterion exceeds said threshold value, then said similarity criterion indicates that said region comprising said landmark points in said reference image correlates to said region comprising said landmark points in said query image.

4. The method of claim 3, wherein said reference image is associated with a genotype, and wherein if said similarity criterion exceeds said threshold value, then said similarity criterion indicates that said test subject possesses said genotype, and wherein if said similarity criterion does not exceed said threshold value, then said similarity criterion indicates that said test subject does not possess said genotype.

5. The method of claim 3, wherein said reference image is associated with a normal biological state, and wherein if said similarity criterion exceeds said threshold value, then said similarity criterion indicates that said test subject is in said normal biological state, and wherein if said similarity criterion does not exceed said threshold value, then said similarity criterion indicates that said test subject is not in said normal biological state.

6. The method of claim 3, wherein said reference image is associated with a disease state, and wherein if said similarity criterion exceeds said threshold value, then said similarity criterion indicates that said test subject is in said disease state, and wherein if said similarity criterion does not exceed said threshold value, then said similarity criterion indicates that said test subject is not in said disease state.

7. The method of claim 6, wherein said disease state comprises a developmental defect.

8. The method of claim 1, wherein said test subject and said reference subject are selected from an ex vivo embryo, an ex vivo fetus, and a tissue sample.

9. The method of claim 8, wherein said ex vivo embryo is a mouse embryo.

10. A virtual histology library formed by compiling a plurality of reference images, wherein each of said reference images is produced by a method comprising:
(a) obtaining a microCT image of a reference subject by a method comprising:
i. incubating a sample from said reference subject in a first staining composition comprising a first staining agent, thereby producing a stained sample;
ii. suspending said stained sample in a liquid having a density lower than that of said stained sample; and
iii. scanning said stained sample in an X-ray computed tomography scanner to produce said microCT image of said stained sample;
(b) identifying landmark points in said microCT image;
(c) generating morphological statistics for a region around said landmark points; and
(d) processing said microCT image using said morphological statistics, thereby producing said reference image.

11. A virtual histology library according to claim 10, wherein said generating said morphological statistics comprises applying a shape-based statistical model to said landmark points.

12. A virtual histology library according to claim 10, wherein said landmark points identify a member selected from: forebrain, midbrain, hindbrain, heart, liver, neural tube, and lung.

13. A virtual histology library according to claim 12, wherein said landmark points identify ventricle and atrial cavities of said heart.

14. A virtual histology library according to claim 10, wherein said first staining agent is selected from osmium tetroxide and phosphotungstic acid.

15. A method for indexing and retrieving stored images based on image content, said method comprising:
(a) selecting a plurality of features from each of a plurality of reference images of at least one reference subject, said plurality of features corresponding to distinct anatomical features of said at least one reference subject;
(b) recording said plurality of features from said plurality of reference images;
(c) indexing said plurality features from said plurality of reference images, wherein said indexing is based on morphological statistics calculated for each of said plurality of features, and wherein said indexing forms a searchable library of said digital images;
(d) selecting a plurality of features from a query image;
(e) calculating morphological statistics for each of said plurality of features from said query image;
(f) searching said library using said morphological statistics for said query image; and
(g) retrieving at least one reference image from said library using a similarity criterion, wherein said similarity criterion is calculated from said morphological statistics from said reference image and said morphological statistics from said query image.

16. The method of claim 15, wherein said plurality of reference images and said query image are microCT images.

17. The method of claim 15, wherein said recording is accomplished using a computer implemented method.

18. The method of claim 15, wherein said indexing comprises assigning each of said plurality of reference images to a group using said morphological statistics for said reference images.

19. A computer implemented method for classifying a subject, said method comprising:
(a) obtaining an image of said subject;
(b) selecting an anatomical feature of said image;
(c) determining a distribution of values for said anatomical feature;
(d) calculating test indices for each of said distribution of values in (c); and
(e) classifying said subject as normal or abnormal by comparing said test indices with reference indices stored in a virtual histology library, wherein said subject is classified as abnormal to an extent that there is a deviation of said test indices from said reference indices.

20. The method of claim 19, wherein said subject is a mouse embryo.
